(19) United States
(12) Patent Application Publication
(10) Pub. No.: US 2013/0163982 A1
(43) Pub. Date: Jun. 27, 2013

(54) TRANSMISSION APPARATUS

(71) Applicant: FUJITSU LIMITED, Kawasaki-shi (JP)

(72) Inventor: Yuji TOCHIO, Yokohama (JP)

(21) Appl. No.: 13/663,814

(22) Filed: Oct. 30, 2012

(30) Foreign Application Priority Data
Dec. 27, 2011 (JP) 2011-287035

(51) Int. Cl. H04B 10/20; H04B 10/08; H04J 14/00

(52) U.S. Cl. 398/2; 398/58; 398/45

(57) ABSTRACT

A transmission apparatus interconnects a core network for making a communication by forming a connection and a metro network for m a communication by adding an address to data and by executing a forwarding process. The transmission apparatus includes a function of transmitting the data to the connection of the core network, to which an address of the metro network is made to correspond, and transfers the data to the connection of the core network, which is made to correspond to the address added to the data received from the metro network.

### CROSS-REFERENCE TO RELATED APPLICATION

This application is based upon and claims the benefit of priority of the prior Japanese Patent Application No. 2011-287035, filed on Dec. 27, 2011, the entire contents of which are incorporated herein by reference.

### FIELD

The embodiment discussed herein is related to a transmission apparatus.

### BACKGROUND

FIG. 1 is a conceptual schematic of a network that connects a core network and a metro network. A network configuration that enables a communication between remote areas by connecting a wide-area network (core network) for making a long-haul transmission between areas, or the like, and metro networks for making a local transmission within an area as illustrated in FIG. 1 has been recently developed.

With a recent increase in a transmission capacity, an OTN (Optical Transport Network) that implements a high transmission capacity of 100G class per transmitter/receiver in a core network and employs a WDM (Wavelength Division Multiplexing) scheme has been introduced. Moreover, Ethernet of a high transmission capacity of 1G or faster (1G, 10G or the like) is being configured also in metro networks similarly to a core network. A wide-area and broadband L2 network (so-called L2VPN (L2 Virtual Private Network) or an E-LAN (Ethernet-Local Area Network) can be formed by connecting metro networks via a core network, so that a configuration of a multipoint connection between wide-area points is being realized.

Conventionally, L2VPN typically employs IP/MPLS (Internet Protocol/Multi-Protocol Label Switching) as a core network. However, a similar network can be realized also by using an OTN (ODU (Optical Data Unit) stipulated by ITU-T G.709).

FIG. 2 is an explanatory view of a configuration of an L2 network where an OTN scheme and Ethernet are respectively employed as a core network and metro networks.

As an E-LAN providing scheme that employs an ODU in a core network, a scheme of connecting edge apparatuses 10 with ODUs in a full mesh state is basically under study similarly to L2VPN using MPLS. An issue raised in this case is handling of traffic of broadcast (transferred by using Unknown MAC (Media Access Control) address) from a metro network. With an MPLS-based VPLS (Virtual Private LAN Service), a function of selecting a port based on a MAC address was handled as a signaling message (for example, referred to in RFC 4762 6.2).

However, since it is needed to handle a very large number of MAC addresses in an MPLS core network, the above described function is not very advantageous. If a MAC learning process is not executed at ODU output ports when an OTN device that does not have signaling is used, there is a problem in terms of a band even in an ODU (having a broad band) due to broadcasting in a full mesh state within an OTN domain.

Conventional techniques include a technique of enabling a frame to be forwarded within an OTN by defining an address corresponding to an OTN for an Ethernet connection in an edge apparatus that connects between the Ethernet and the OTN so as to support an Ethernet connection.

### PRIOR ART DOCUMENT

### Patent Document

[patent Document 1] Japanese National Publication of International Patent Application No. 2010-520663

### SUMMARY

A transmission apparatus in one aspect of the following embodiment is a transmission apparatus that interconnects a first network for making a communication by forming a path and a second network for making a communication by adding an address to data and by executing a forwarding process. The transmission apparatus includes: a plurality of transmission units that are provided for each path and configured to transmit data to the path of the first network, to which the address of the second network is made to correspond; and a transfer unit configured to receive the data of the second network, and to transfer the data to one of the plurality of transmission units, which corresponds to the address of the data.

According to the following embodiment, a transmission apparatus that can save a band in a network connecting metro networks via a core network can be provided.

The object and advantages of the invention will be realized and attained by means of the elements and combinations particularly pointed out in the claims.

It is to be understood that both the forgoing general description and the following detailed description are exemplary and explanatory and are not restrictive of the invention, as claimed.

### BRIEF DESCRIPTION OF DRAWINGS

FIG. 1 is a conceptual schematic of a network that connects a core network and metro networks;

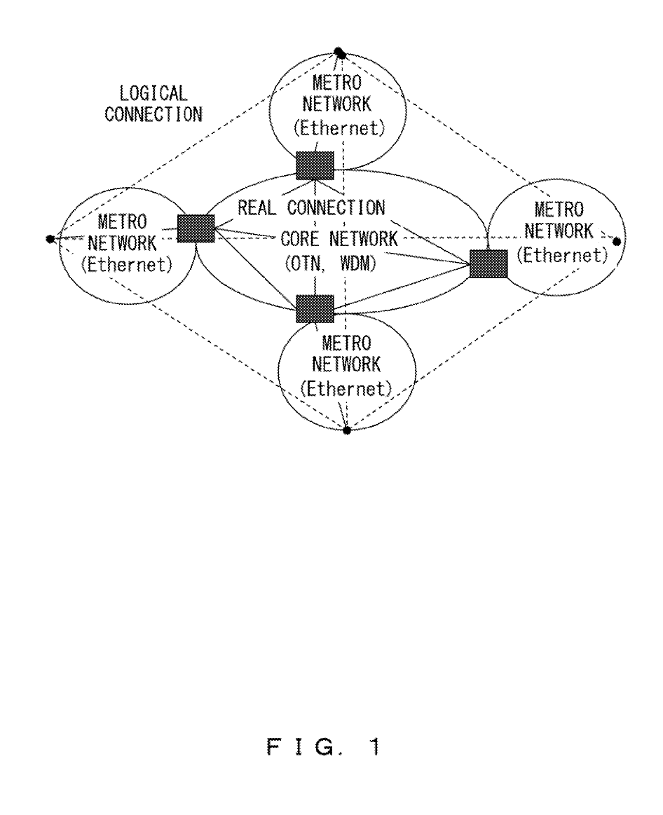

FIG. 2 is an explanatory view of a configuration of an L2 network that respectively employs an OTN scheme and Ethernet as a core network and metro networks;

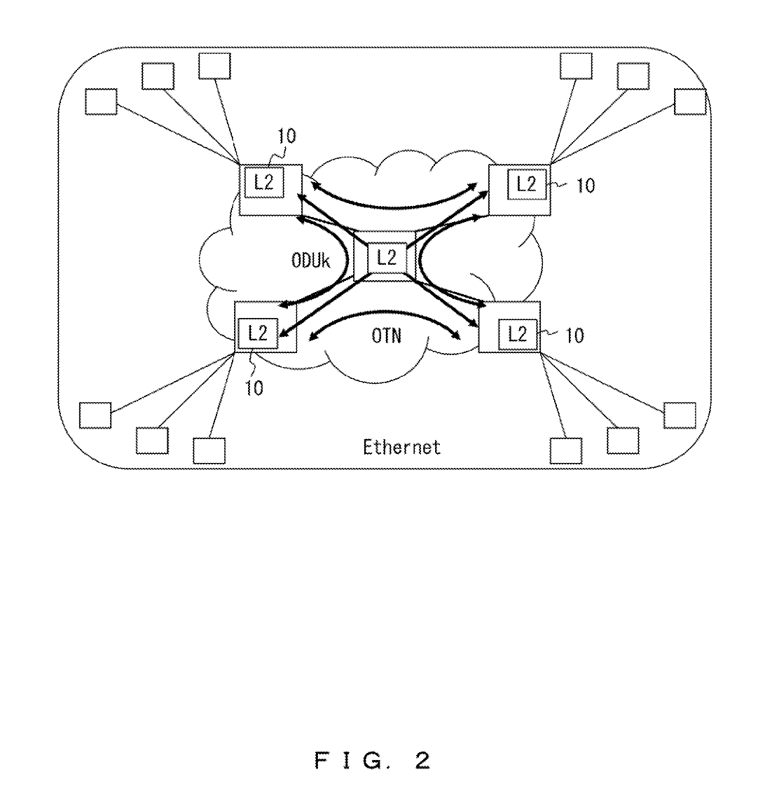

FIG. 3 is an explanatory view (No. 1) of a case where a PBB process is used for an edge apparatus, which is a transmission apparatus;

FIG. 4 is an explanatory view (No. 2) of the case where the PBB process is used for the edge apparatus, which is the transmission apparatus;

FIG. 5 is an explanatory view (No. 3) of the case where the PBB process is used for the edge apparatus, which is the transmission apparatus;

FIG. 6 is an explanatory view of a problem posed when PBB is applied;

FIG. 7 illustrates a flow of a frame in an embodiment;

FIG. 8 is a block diagram illustrating a configuration of hardware of an edge apparatus according to this embodiment;

FIG. 9 illustrates a configuration of functional blocks of the edge apparatus according to this embodiment;

FIG. 10 is an explanatory view of learning operations of a MAC learning table that makes B-MAC and an ODU correspond to each other in the edge apparatus according to this embodiment;

FIG. 11 is an explanatory view of a case where the edge apparatus has not learned B-MAC yet;

FIG. 12 illustrates an example of a way of setting an ODU;

FIG. 13 illustrates a configuration example (No. 1) of this embodiment when MPLS is assumed as a core network;

FIG. 14 illustrates a configuration example (No. 2) of this embodiment when MPLS is assumed as the core network;

FIG. 15 illustrates a configuration example (No. 3) of this embodiment when MPLS is assumed as the core network;

FIG. 16 is an explanatory view (No. 1) of a configuration example for assigning a MAC address to a port linking to an ODU path of the edge apparatus;

FIG. 17 illustrates a configuration example (No. 2) of for assigning a MAC address to a port linking to an ODU path of the edge apparatus;

FIG. 18 is an explanatory view (No. 1) of a case where a redundant configuration is employed;

FIG. 19 is an explanatory view (No. 2) of a case where a redundant configuration is employed;

FIG. 20 is an explanatory view (No. 3) of a case where a redundant configuration is employed; and

FIG. 21 is an explanatory view (No. 4) of a case where a redundant configuration is employed.

### DESCRIPTION OF EMBODIMENTS

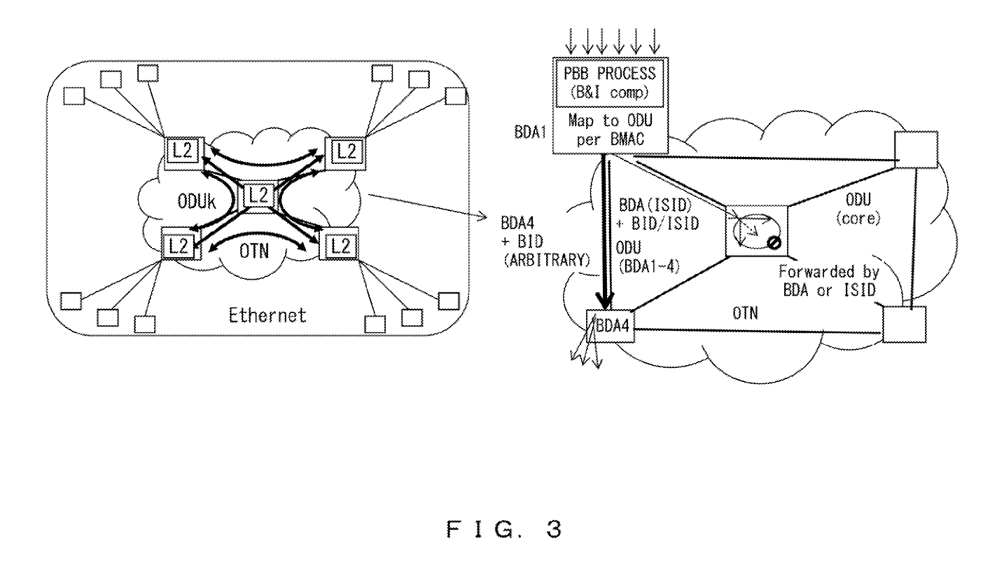

FIGS. 3 to 5 are explanatory views of a case where a PBB process is used for an edge apparatus, which is a transmission apparatus.

The edge apparatus can switch and map a packet to an ODU by executing a process stipulated by IEEE 802.1ah, namely, a PBB (Provider Backbone Bridge) process. By learning B-MAC (Backbone-Media Access Control) of an opposing ODU, the volume of broadcasting can be reduced.

With the PBB process, a header that stores B-MAC for being transferred in an OTN is added to a received packet in addition to a C-MAC address, and the packet is transmitted by an ODU to a transfer destination specified by the B-MAC. The header including the B-MAC is removed by an edge apparatus at the transfer destination, and transmitted to a destination specified by the C-MAC address.

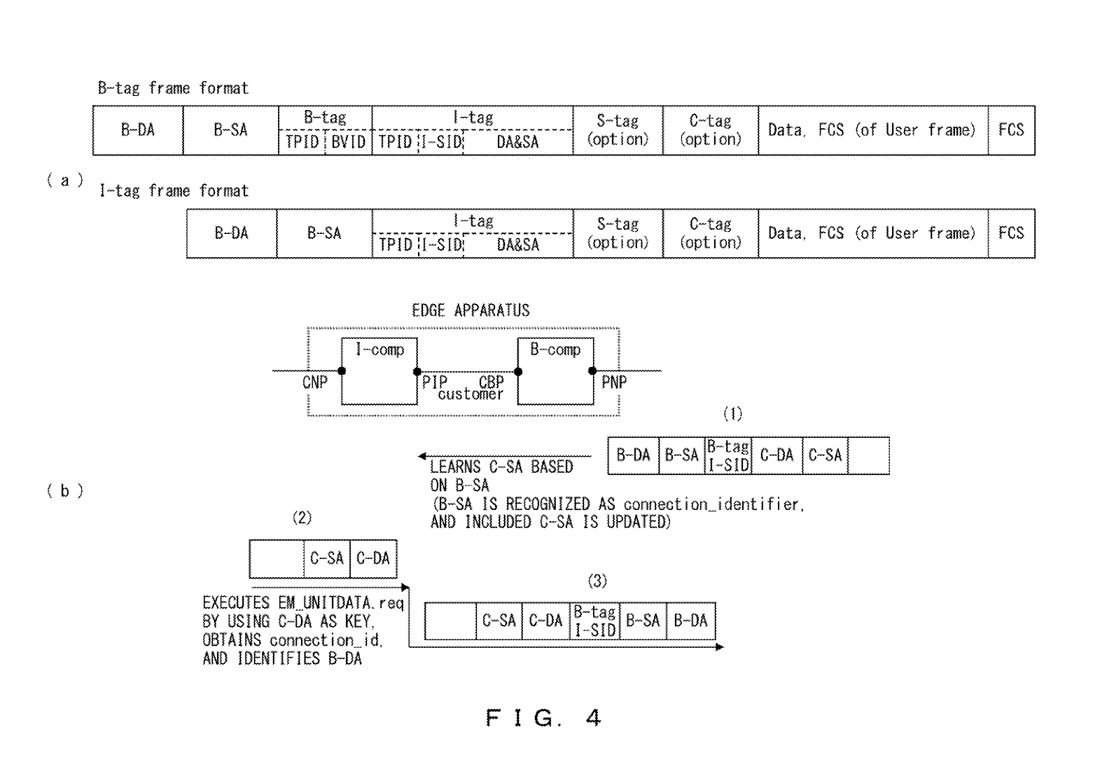

FIG. 4 is an explanatory view of PBB.

FIG. 4(a) illustrates a frame format of PBB. An upper portion of FIG. 4(a) illustrates a B-tag frame format, whereas a lower portion of FIG. 4(a) illustrates an I-tag frame format. In these formats, a header named I-tag (including a MAC destination address (DA) and a MAC source address (SA)) is attached along with an S-tag and a C-tag as options before a user frame. The S-tag and the C-tag respectively include S-DA and S-SA, and C-DA and C-SA, which are options and not illustrated. In the B-tag frame format, a header named B-tag is attached before I-tag. Moreover, B-DA and B-SA are added to the beginning. As described above, a MAC frame is configured as layers by further attaching a header including MAC addresses to a header including MAC addresses. Therefore, such encapsulation is called MAC-in-MAC.

B-DA is Backbone Destination Address, whereas B-SA is Backbone Source Address. The B-DA and the B-SA are used to transfer a frame within a core network, which is a backbone network. The B-SA is a source address within the backbone network, whereas the B-DA is a destination address within the backbone network.

FIG. 4(b) is an explanatory view of a MAC learning process executed by an edge apparatus in the PBB.

If a frame is transferred from an apparatus indicated by B-SA to an apparatus indicated by B-DA, the edge apparatus learns that the frame of (1) from the device indicated by the B-SA of the frame is transferred from the device indicated by C-SA. The C-SA is a source address of the frame within the metro network, whereas C-DA is a destination address of the frame within another metro network connected by a core network. As a result of the learning using the frame of (1), the B-SA is recognized as connection identifier, and the destination of the connection is recognized to be the C-SA.

When a frame in a reverse direction is input to the edge apparatus, a connection that matches the learned C-SA is searched by referencing C-DA of the frame of (2), and the B-SA of (1) is obtained as the B-DA of the frame of (2). Then, the B-SA and the B-DA are added as a header to the frame as illustrated in (3) by using the B-DA detected in this way, and the frame is transferred within the backbone network. The B-SA and the B-DA are collectively called B-MAC.

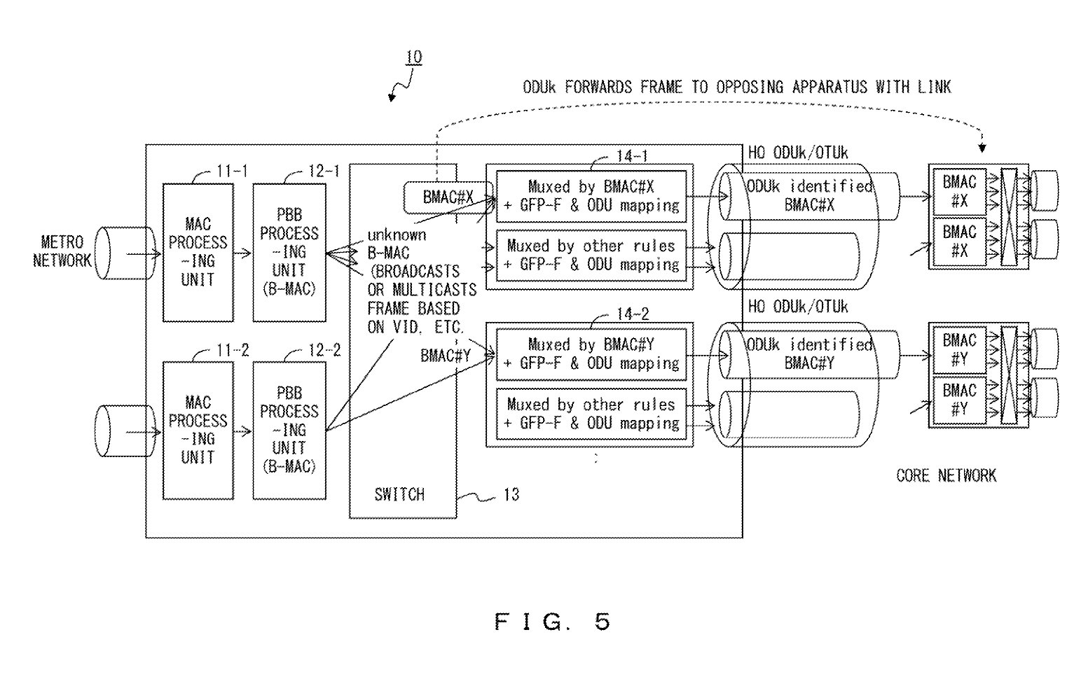

FIG. 5 is a block diagram illustrating a configuration of the edge apparatus when executing the PBB process. MAC processing units 11-1, 11-2 execute a MAC process (an address analysis and header attachment) for a frame input from the metro network to the edge apparatus 10, and input the frame to PBB processing units 12-1, 12-2. The PBB processing units 12-1, 12-2 add B-MAC to the frame. A switch 13 executes a switching process for the frame based on the B-MAC, and transmits the frame to a corresponding ODU processing block 14-1 or 14-2. The ODU processing block (14-1 or 14-2) executes a multiplexing process for the frame based on the B-MAC, and maps the frame to an ODU frame. Thus configured ODU frame is transmitted to an opposing apparatus by using an ODU link.

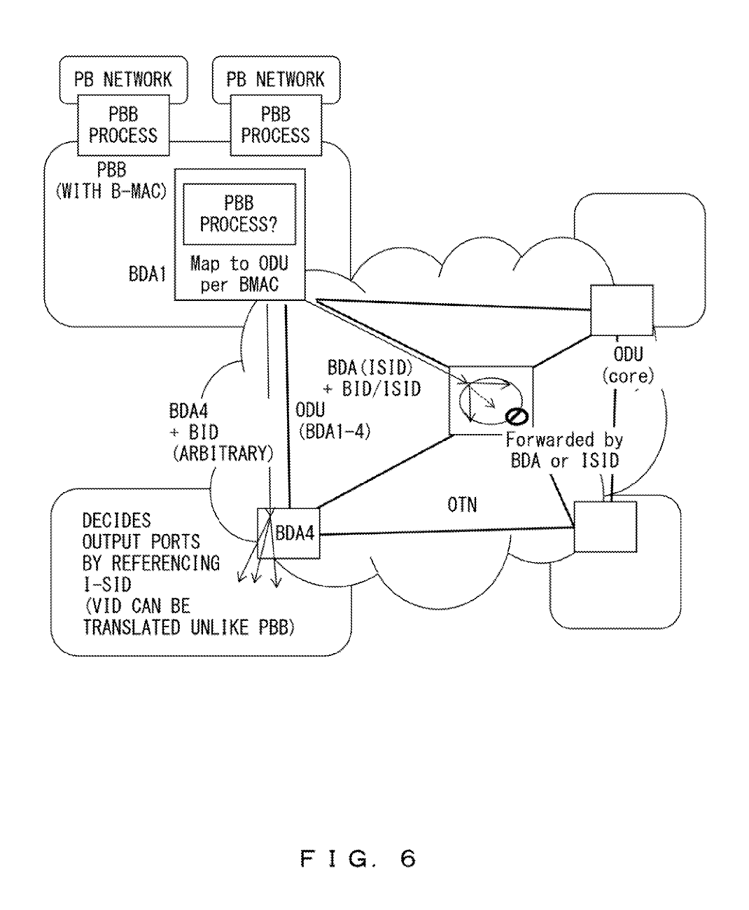

FIG. 6 is an explanatory view of problems posed when PBB is applied.

If a source Ethernet is a PBB network and B-MAC has been already added as illustrated in FIG. 6, the scheme for adding B-MAC is not applied unchanged. The PBB process can be additionally executed to add one more B-MAC and an I-SID (Backbone Service Instance Identifier) and the like. However, this increases the header, leading to a disadvantage of consuming a band of the core network due to the attachment of the header (18 bytes).

Furthermore, if PBB is employed as illustrated in FIGS. 3 to 5, it is needed to decide to which ODU path data is to be transmitted based on B-MAC, and to execute a switching process for the data received from Ethernet so as to transfer the data to the decided ODU path.

Also if the edge apparatus is accommodated in an OTN by using MPLS in conformity with L2VPN (described in detail by the IETF draft named draft-ietf-12vpn-pbb-pe-model), a header (label) needs to be attached, leading to consumption of a band similarly.

Accordingly, the OTN edge apparatus that accommodates Ethernet and transmits a frame in an OTN needs the above described band reductions (flooding, and reductions in attached headers) of the core network.

This embodiment is applied to a so-called edge apparatus positioned at a connecting part of a network that forms Ethernet, especially, a backbone also in a case where PBB is applied and an OTN (MPLS-TP (MPLS-Transport Profile) network is also available). By defining B-MAC or addresses equivalent to B-MAC at both ends of an ODU path formed between edge apparatuses, a frame can be forwarded within the OTN based on B-MAC (more precisely, Outer MAC defined by Ethernet) decided and attached by the operations performed by the Ethernet edge (not the OTN side apparatus).

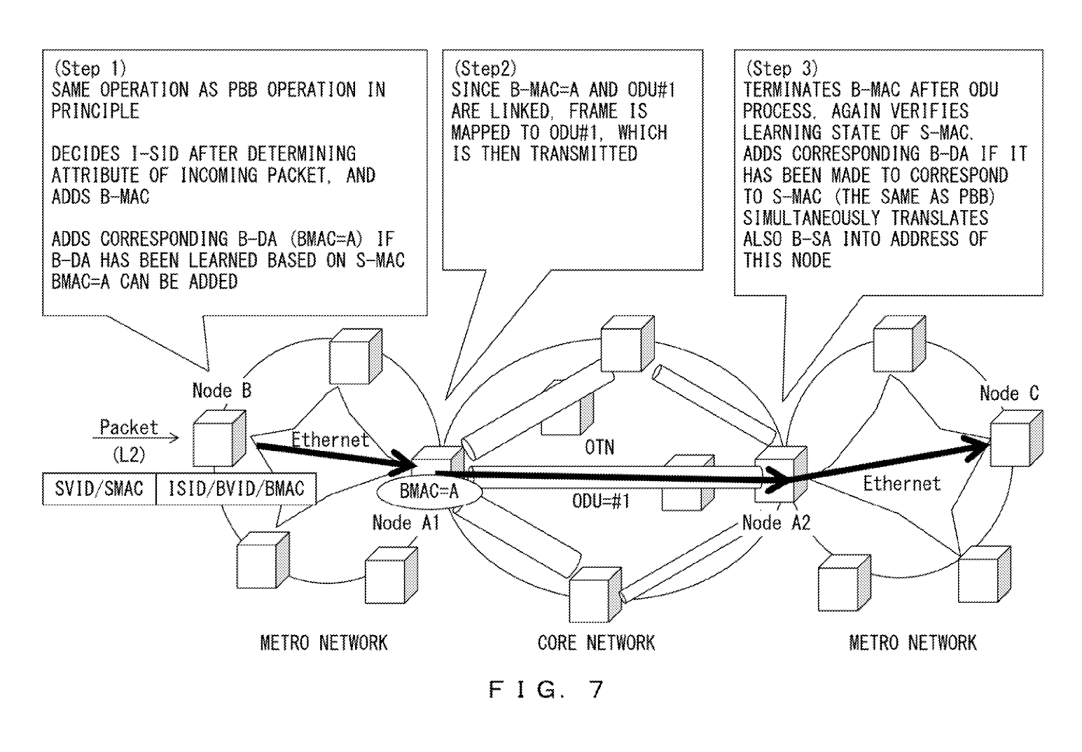

FIG. 7 illustrates a flow of a frame in this embodiment.

The flow of the frame is indicated by three major steps. In step 1, a packet is transmitted from Node B of a metro network employing PBB. Node B determines an attribute of the input packet, decides an I-SID (Service IDentifier), and adds B-MAC to the packet. As B-DA of the packet, a corresponding B-DA is added if Node B has already learned B-DA based on S-MAC (destination address (DA) and a source address (SA) included in the S-tag). Here, assume that “A” is set as B-MAC.

In an edge apparatus (Node A1) between the metro network and the core network, B-MAC=A and ODU=#1 (ODU identifier) are linked to each other. Therefore, the frame having B-MAC=A is mapped to ODU#1 and transmitted. An edge apparatus (Node A2) at an exit of the core network terminates the B-MAC after processing the received ODU frame. Then, Node A2 verifies the learned state of S-MAC, and adds a corresponding B-DA as B-DA if the B-DA is made to correspond to an address to Node C within the metro network based on the S-MAC. At the same time, also the B-SA is translated into an address of Node A2. Then, the frame is transmitted to the metro network. Here, it is assumed that the source address and the destination address of the metro network are set as S-MAC. However, the addresses may be set as C-MAC. Whether the source address and the destination address are set either as S-MAC or as C-MAC depends on a layered structure of the network.

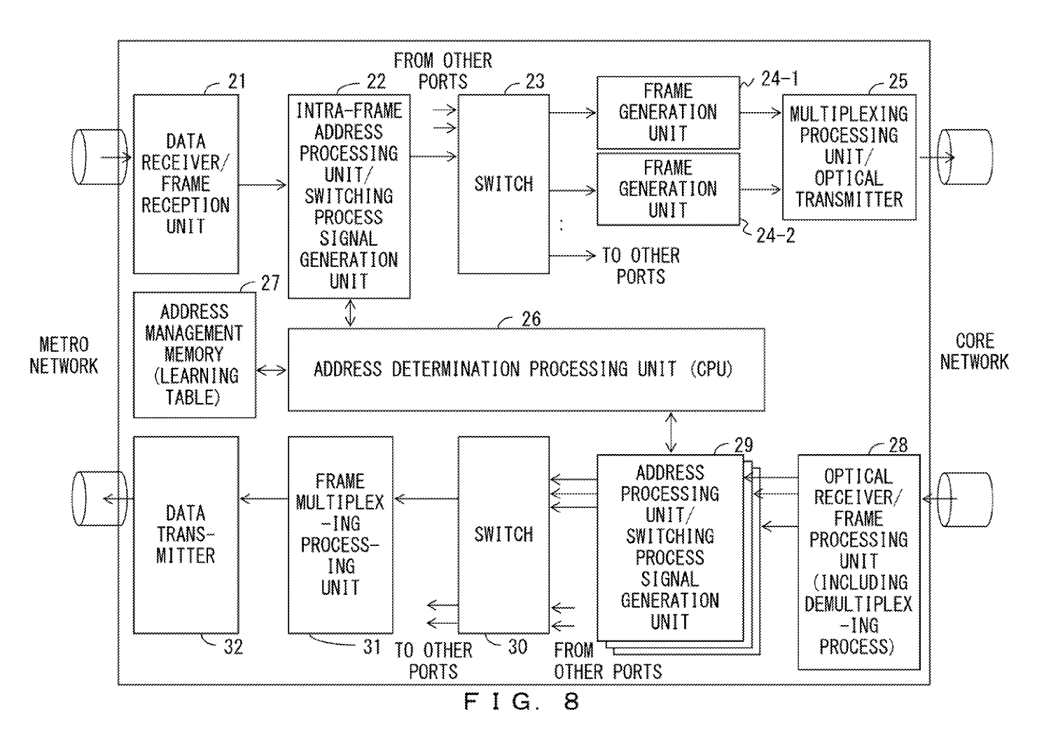

FIG. 8 is a block diagram illustrating a configuration of hardware of the edge apparatus according to this embodiment.

Data from the metro network is received by a data receiver/frame reception unit 21, and input to an intra-frame address processing unit 22. An address determination processing unit 26, which is a CPU, references an address learning table in an address management memory 27, and causes the intra-frame address processing unit 22 to generate a switching process frame. Namely, a signal for transferring a frame to a connection corresponding to an address within the frame is generated. A switch 23 switches the switching process signal generated by the intra-frame address processing unit 22, and transmits the signal to a connection to be used to transfer the frame. Each of frame generation units 24-1, 24-2 configures the input signal as a frame for the core network. A multiplexing processing unit/optical transmitter 25 multiplexes frames generated by the frame generation units 24-1, 24-2, and transmits the multiplexed frame to the core network as an optical signal.

Upon receipt of a signal from the core network, an optical receiver 28 executes a frame process, and demultiplexes the multiplexed optical signal. An address processing unit 29 generates a switching process signal under the control of the address determination processing unit 26 that references the address management memory 27. A switch 30 switches the switching process signal generated by the address processing unit 29. A frame multiplexing processing unit 31 executes a multiplexing process for the switched signal so as to transfer the signal within the metro network. A data transmitter 32 transmits the signal to the metro network.

Other ports of the switches 23, 30 are ports to which a frame for which the processes of this embodiment are not executed is input, and which execute a switching process to output the frame.

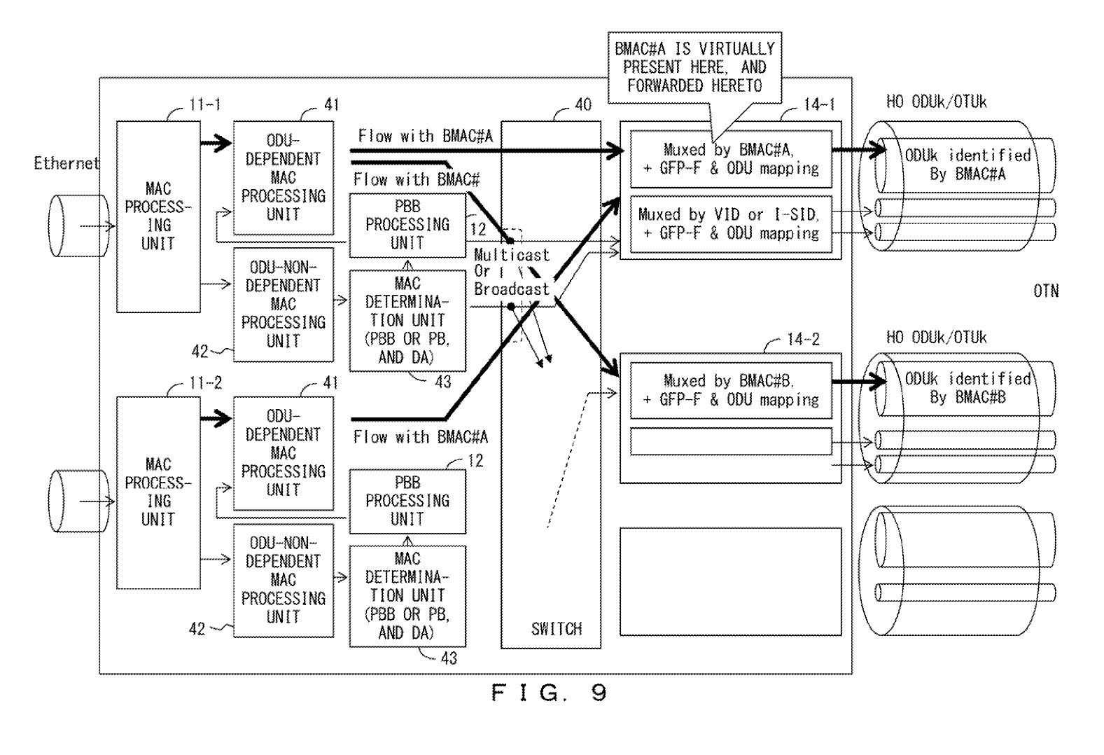

FIG. 9 is a functional block diagram illustrating functions of the edge apparatus according to this embodiment.

In FIG. 9, like components are denoted with like reference numerals of FIG. 5.

FIG. 9 illustrates a configuration the edge apparatus (Node A1 or Node A2). An ODU formed between points is formed for each port on an OTN side. When viewed from an Ethernet side, a switching process is executed by a switch 40 for an Ethernet frame input from each port, and input to an ODU after a GFP (Generic Framing Procedure: frame assembly) is executed. With this process, a MAC address is assigned (defined) according to each ODU.

According to a packet flow when viewed from Ethernet,

MAC (DA) added by the Ethernet edge apparatus results in the MAC address added according to an ODU based on results of learning or the like as illustrated in FIG. 7. Consequently, the packet is forwarded up to opposing Ethernet (or another network) via the ODU network.

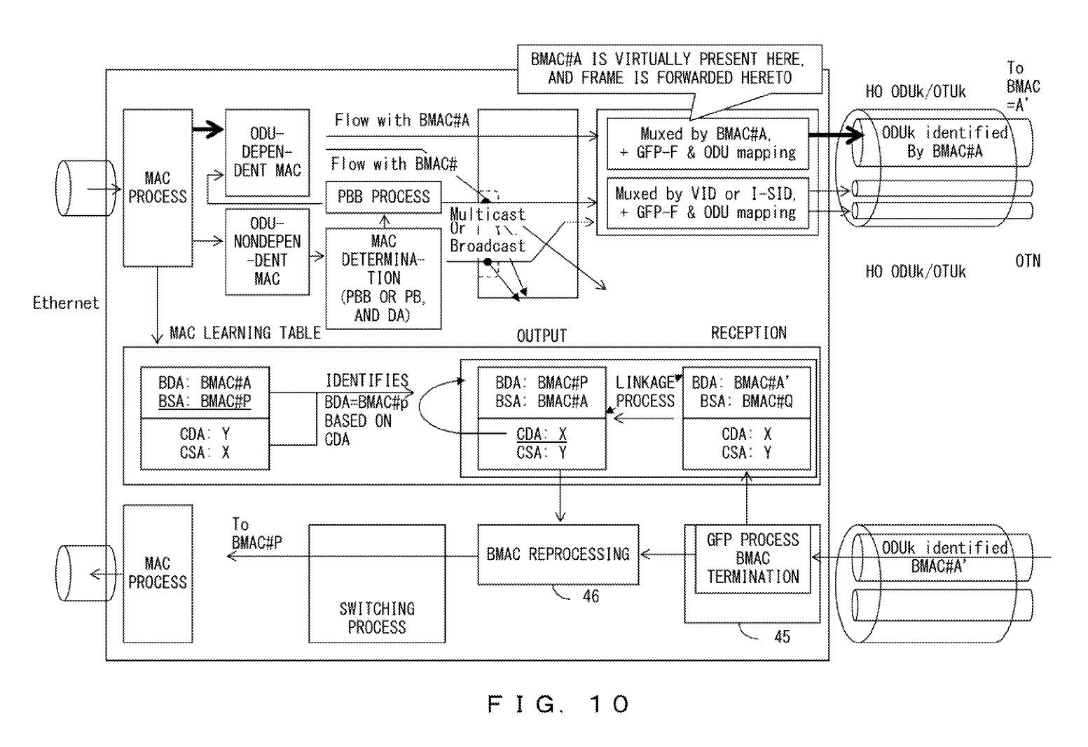

When a frame is input from Ethernet, each of the MAC processing units 11-1, 11-2 executes a MAC process. A frame having B-MAC that is not recorded in the learning table illustrated in FIG. 10 is processed by an ODU-nondependent MAC processing unit 42, and whether to employ either PB (Provider Bridges: a scheme of attaching one more VLAN tag within a network of a carrier) or PBB (a developed method of PB for increasing stability of a network by tunneling a user packet), and also a destination address (DA) of the frame are determined by the MAC determination unit 43. If it is determined that PBB is employed, the PBB process is executed for the frame by the PBB processing units 12-1, 12-2, the frame is multiplexed by the multiplexing units 14-1, 14-2, and transmitted. A frame having C-DA recorded in the learning table illustrated in FIG. 10 among frames for which the PBB process has been executed is input to an ODU-dependent MAC processing unit 41.

A frame having B-MAC that is recorded in the learning table illustrated in FIG. 10 is input to the ODU-dependent MAC processing unit 41. The ODU-dependent MAC processing unit 41 transfers the frame to a corresponding multiplexing unit 14-1 or 14-2 of a corresponding ODU path via the switch 40 based on the B-MAC of the input frame. Here, B-MAC and an ODU path are made to correspond to each other, and to which ODU path a frame is to be transferred is proved by referencing the B-MAC address of the input frame. Specifically, frames are distributed to the multiplexing units 14-1, 14-2 connected to each ODU path made to correspond to a B-MAC address based on B-MAC. Then, the frame is transmitted from the multiplexing unit 14-1 or 14-2 to which the frame has been distributed, so that the frame is transmitted to the corresponding ODU path. Moreover, an output destination of a frame having B-MAC and C-DA that are recorded in the learning table of FIG. 10 is decided based on the B-MAC. Therefore, the process for switching an output destination by analyzing B-MAC is not executed unlike the case where PBB is employed for a connection to an ODU as illustrated in FIGS. 3 to 5.

FIG. 10 is an explanatory view of learning operations of the MAC learning table that makes B-MAC and an ODU correspond to each other in the edge apparatus according to this embodiment.

Operations for identifying B-DA=P based on C-DA=X for a frame transmitted from the OTN are described. Here, assume that BMAC#A′ and BMAC#A are set as MAC addresses at an entry and an exit of an ODU path to be used.

A reception unit 45 receives a frame having B-DA, B-SA, C-DA and C-SA that are respectively BMAC#A′, BMAC#Q, X and Y from the OTN, and outputs the frame to a BMAC reprocessing unit 46, which changes the B-DA to B-SA in the frame. Conventional B-SA=BMAC#Q is not used at this time point. Namely, the B-DA is undecided, the B-SA is BMAC#A, the C-DA is X, and the C-SA is Y.

B-DA:BMAC#P is assigned according to a learning state.

Assume that a frame having B-DA, B-SA, C-DA and C-SA that are respectively BMAC#A, BMAC#P, Y and X, namely, a frame having a combination of B-SA=BMAC#P and C-SA=BMAC#X has been received from Ethernet and has been already learned. In this case, an operation for identifying the undecided B-DA=BMAC#P as the B-DA of the destination based on the learned B-SA by making the learned C-SA and the C-DA of the destination correspond to each other is performed, so that the frame can be forwarded to BMAC#P. The frame the destination of which has been decided in this way is configured by the BMAC processing unit 46 as a switching process frame, for which the switching process is then executed. After the switching process has been executed, a MAC process is executed for the frame, which is then transmitted to the Ethernet destination node. Note that BMAC#A′ of the B-DA of the received frame, and BMAC#A of the B-SA of the transmitted frame are respectively set as MAC addresses at the entry and the exit of the ODU path, and these addresses are made to correspond to each other.

The operation for identifying B-DA is performed in conformity with IEEE 802.1ah. FIG. 10 illustrates the operations performed when an address has been already learned.

VLAN (Virtual LAN) is not referred to in the frame process. However, the frame process is based on the premise that IEEE 802.1ah is accommodated by an OTN. Namely, the information such that the B-DA, the B-SA, the C-DA and the C-SA are respectively BMAC#P, BMAC#A, X and Y is based on the premise that the frame is forwarded in a domain defined by BVID (Backbone VLAN ID), and MAC address forwarding in the domain is assumed.

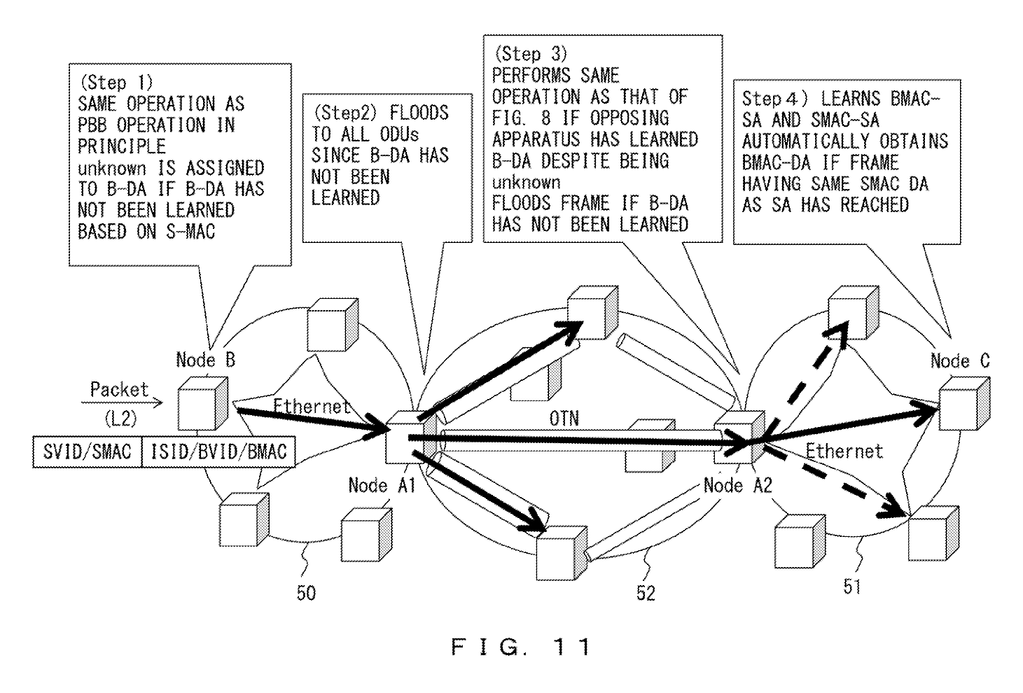

FIG. 11 is an explanatory view of a case where the edge apparatus has not learned B-MAC yet.

Node B in an Ethernet 50 metro network performs the PBB process to transmit a frame. If Node B has not learned B-DA based on S-MAC at this time, “unknown” is assigned to B-DA. Since the B-DA has not been learned yet, the edge apparatus Node A1 of OTN 52 broadcasts (floods) the same frame to all ODUs. Node A2 that has received the frame from Node A1 identifies B-DA similarly to FIG. 10 if Node A2 has learned a transfer to Node-C although the B-DA has not been learned yet. Then, Node A2 transfers the frame. If the transfer to Node C has not been learned yet, a flooding process is executed for the received frame toward Ethernet 51. Node C has learned B-SA of B-MAC and S-SA of S-MAC. If a frame having the same S-DA as S-SA (If S-DA specifies Node C) has reached (if S-DA specifies Node C), Node C automatically sets the address of the B-SA as the B-DA of the B-MAC of the frame to be transmitted from Node C.

The above embodiment has been described based on the configuration where the PBB network is connected with the OTN. However, the embodiment may be applicable if the Ethernet is PB (IEEE 802.1ad).

There are the following cases.
(1) PBB-OTN (line network)-PB
(2) PB-OTN (line network)-PB

For (1) and (2), a process for OTN→PB (for transferring a frame from OTN to PB) or a reverse process is needed. As the process for PB→OTN (for transferring a frame from PB to OTN), the process of FIG. 9 by the ODU-nondependent MAC processing unit 42 is executed. In this block, operations for determining C-DA and for identifying BMAC=BMAC#A′ or A are performed. Then, the frame is mapped to ODUk defined based on BMAC#A, and transmitted to an opposing node. As the process for OTN→PB, a process of the PBB edge node that does not execute the BMAC process is simply applied. In this case, a function of learning BMAC-SA (B-SA) and CMAC-SA (C-SA) is provided.

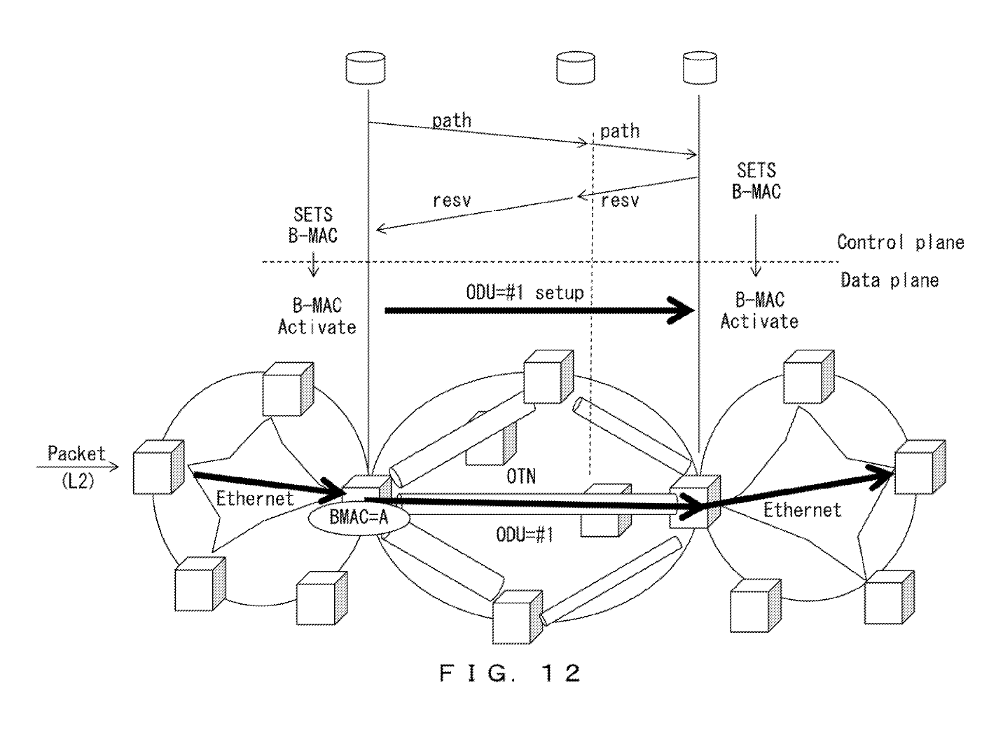

FIG. 12 illustrates an example of a way of setting an ODU.

ODU setting can be realized as an extended definition (RSVP-TE) of GMPLS (a technique of applying a method of creating an MPLS path to a method of forming a path of an optical transmission network, and of making IP and an optical transmission networks cooperate with each other) signaling. An opposing node that has received a frame from an ODU path sets an address of the local node as a B-MAC corresponding to the ODU path at this time point, and the node that has set the ODU sets the address of the local node as B-MAC at timing of receiving Resv (RSVP reservation) (at timing of establishing a path). At this time point when the B-MAC is set, the MAC address can be made to correspond to the ODU path. Specifically, this is realized with an extension of [draft-ietf-ccamp-rsvp-te-sdh-otn-oam-ext].

The ODU has been assumed as the core network up to this point. However, MPLS or SDH (Synchronous Digital Hierarchy) can be used as the core network.

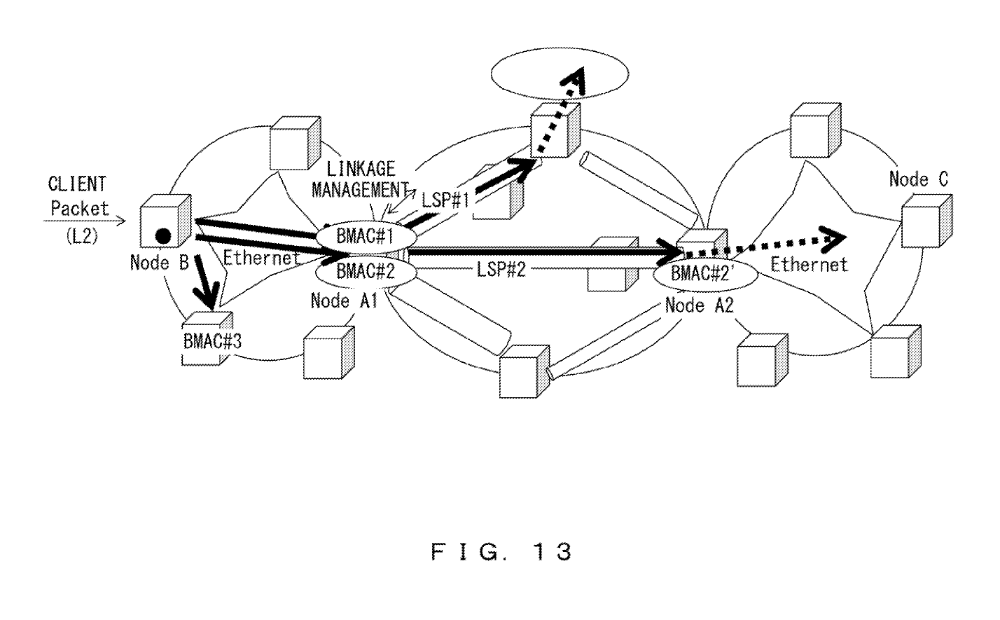

FIGS. 13 to 15 illustrate an example of a configuration according to this embodiment by assuming MPLS as the core network.

In FIG. 13, a frame is transmitted from Node B of the PBB network to BMAC#1 of Node A1. Here, LSP#1 and LSP#2 of the MPLS network are mapped to BMAC#1 in Node A1. By using LSP#1 and LSP#2, the frame is transferred to an opposing edge apparatus. In FIG. 13, LSP#2 is connected up to Node A2. The frame is transferred up to Node C from Node A2 to Node C by using the learned B-MAC.

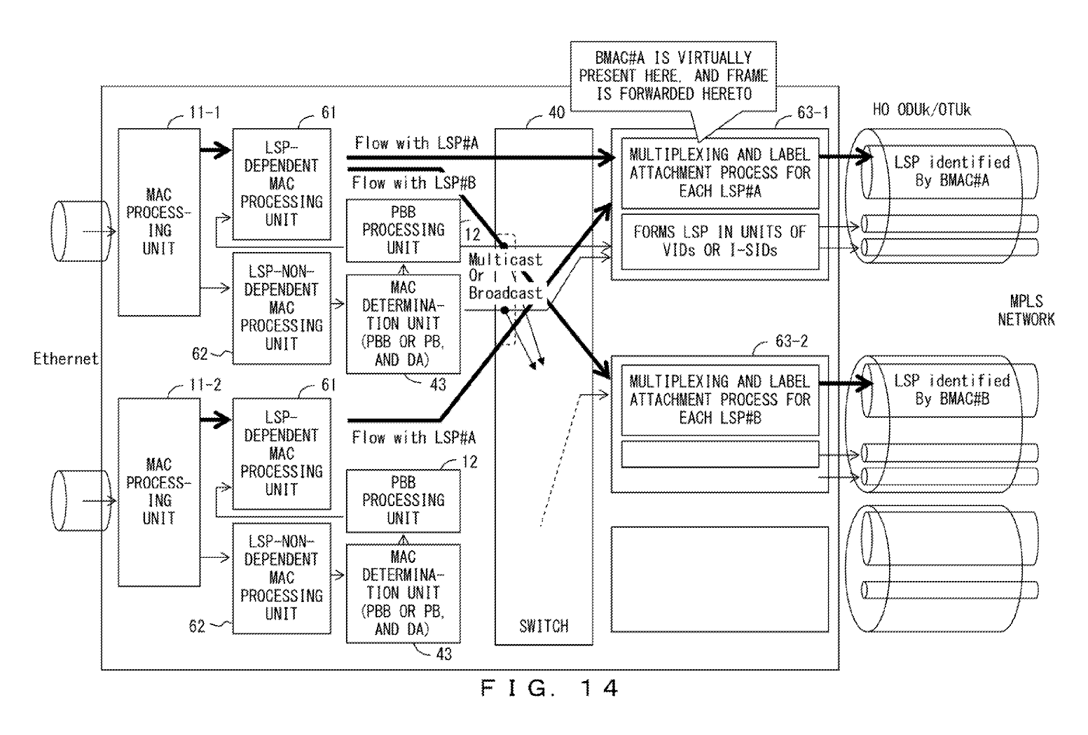

FIG. 14 illustrates an example of a configuration of the edge apparatus implemented when this embodiment is applied to the MPLS network.

In FIG. 14, like components are denoted with like reference numerals of FIG. 9.

In FIG. 9, the ODU-dependent MAC processing unit and the ODU-nondependent MAC processing unit are provided, and the multiplexing units are provided in units of ODUs. In FIG. 14, however, an LSP-dependent MAC processing unit 61 and an LSP-nondependent MAC processing unit 62 are provided, and multiplexing units 53-1 and 63-2 multiplex frames in units of LSPs, and execute a label attachment process. Moreover, a path is identified by an ODU within the OTN in FIG. 9. In contrast, a path is identified by an LSP within an MPLS network in FIG. 14.

Accordingly, a difference between the OTN of FIG. 9 and the MPLS network of FIG. 14 is that B-MAC is assigned for each LSP in the MPLS network although B-MAC is assigned to each ODU in the OTN.

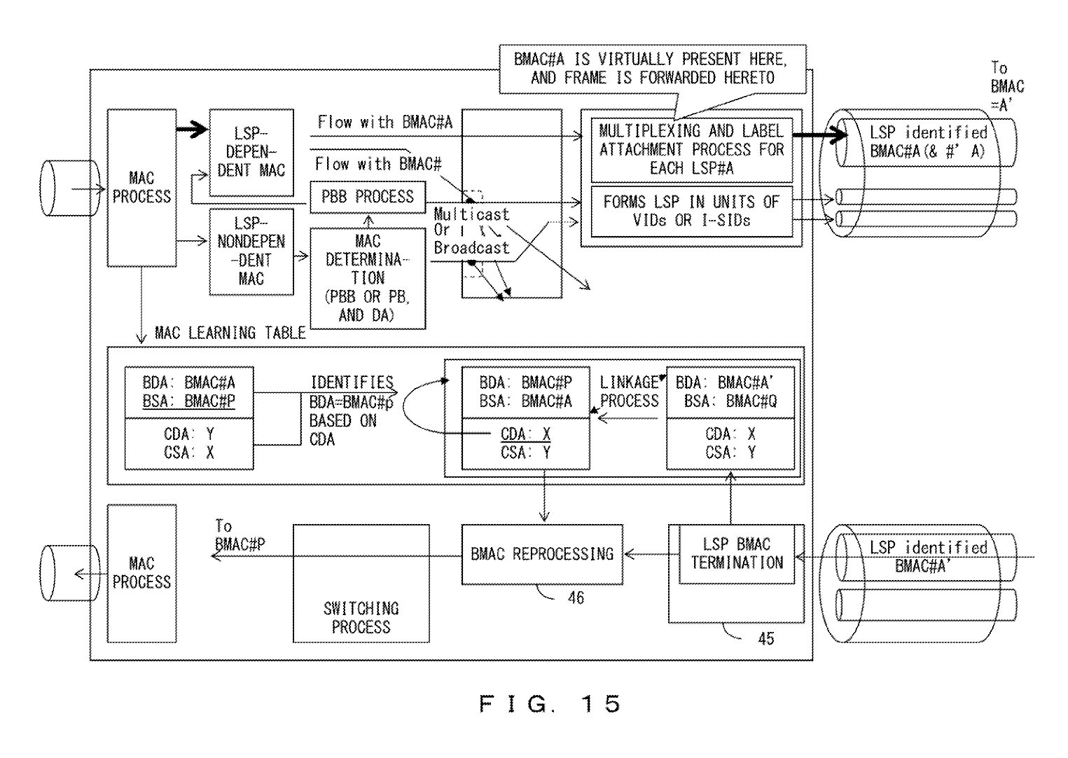

FIG. 15 illustrates a state of learning performed in the edge apparatus when being applied to the MPLS network.

FIG. 15 is also different from FIG. 10 in that an LSP is provided as a replacement for an ODU although B-MAC is assigned to each ODU path and a frame is transmitted to the ODU path based on learned B-MAC in FIG. 10. Accordingly, since the learning process of B-MAC is the same as that in FIG. 10, its explanation is omitted.

Additionally, the learning process can be similarly realized by using an SDH frame as a replacement for the above described MPLS frame.

In the above described embodiment, MAC addresses are defined at both ends of an ODU path. However, only one address can be defined for a connection.

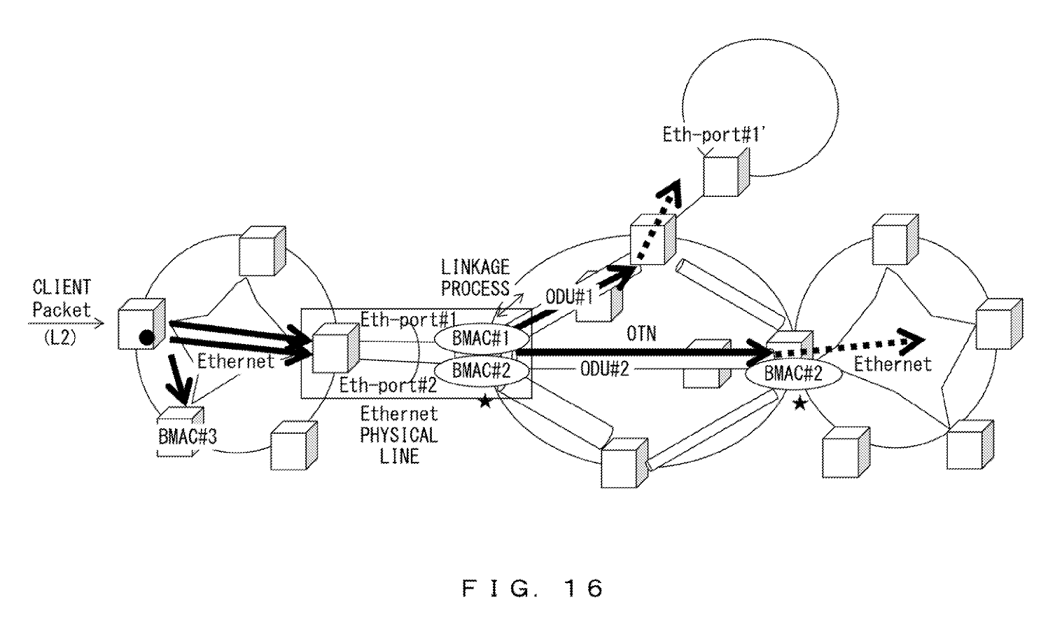

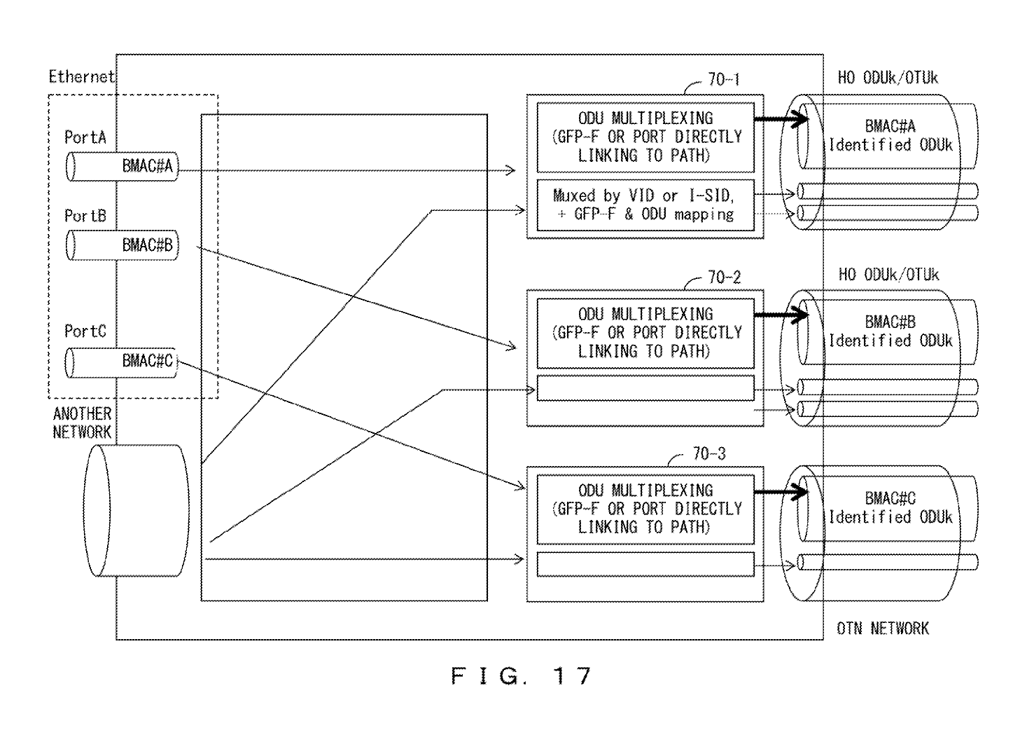

FIGS. 16 and 17 are explanatory views of an example of a configuration for assigning a MAC address to a port linking to an ODU path of the edge apparatus.

In the embodiment illustrated in FIGS. 7 to 12, MAC addresses are virtually assigned to input and output ends of an ODU. However, a corresponding MAC address can be defined, by way of example, for a GbE port via a Gb class port such as GbE port (Gb class Ethernet port) that directly accommodates an ODUk. FIG. 16 illustrates its outline. By managing Eth-port#1 (and its opposing side Eth-port#1′) and ODU#1 with an integrating link, BMAC#1 corresponds to an address defined by Eth-port#1. The number represented by Eth-port#i is, for example, the number represented by ODU#i. By way of example, for an OTN composed of n nodes, n−1 Ethernet ports are provided.

FIG. 17 illustrates a configuration for Ethernet→OTN. This is implemented by the above described operation for mapping BMAC to an ODU. An operation in the reverse direction is the same as that illustrated in FIG. 10. An output destination after a MAC address analysis and header attachment corresponds to Eth-port#1.

In FIG. 17, BMAC#A to BMAC#C are made to respectively correspond to input ports A to C from Ethernet. A frame is transferred from each of the ports to any of multiplexing units 70-1 to 70-3 to an ODU path identified with each of BMAC#A to BMAC#C, and transmitted from each of the multiplexing units 70-1 to 70-3 to an OTN. Here, there are only wires to the corresponding multiplexing units from the ports, and a switching process is not needed.

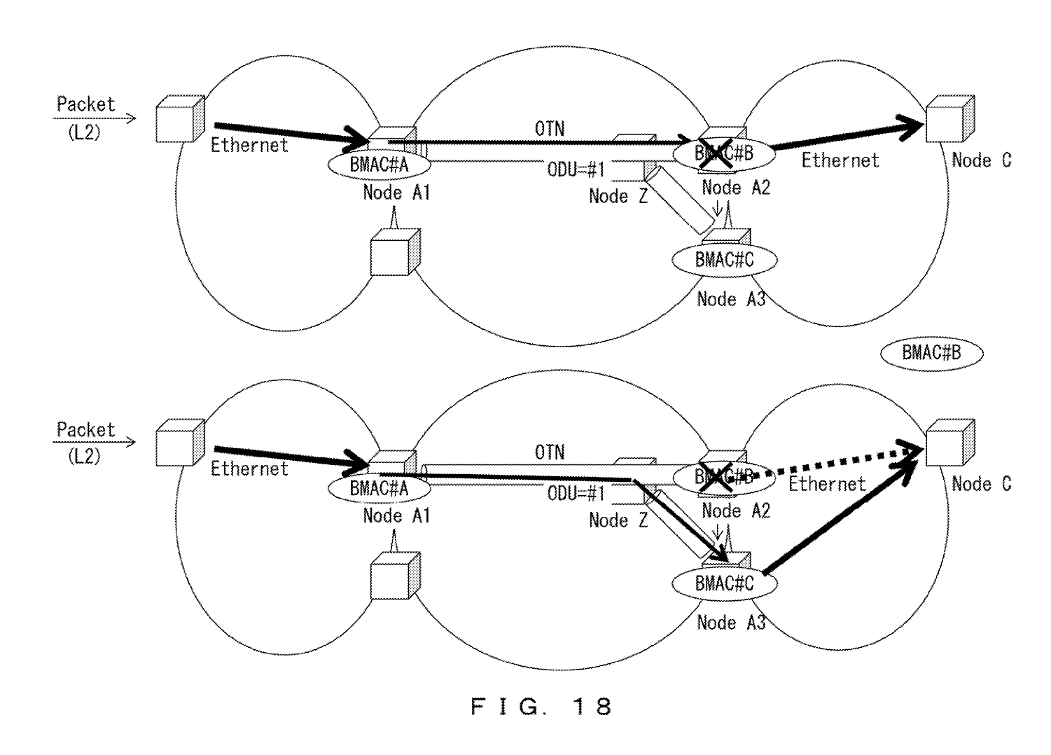

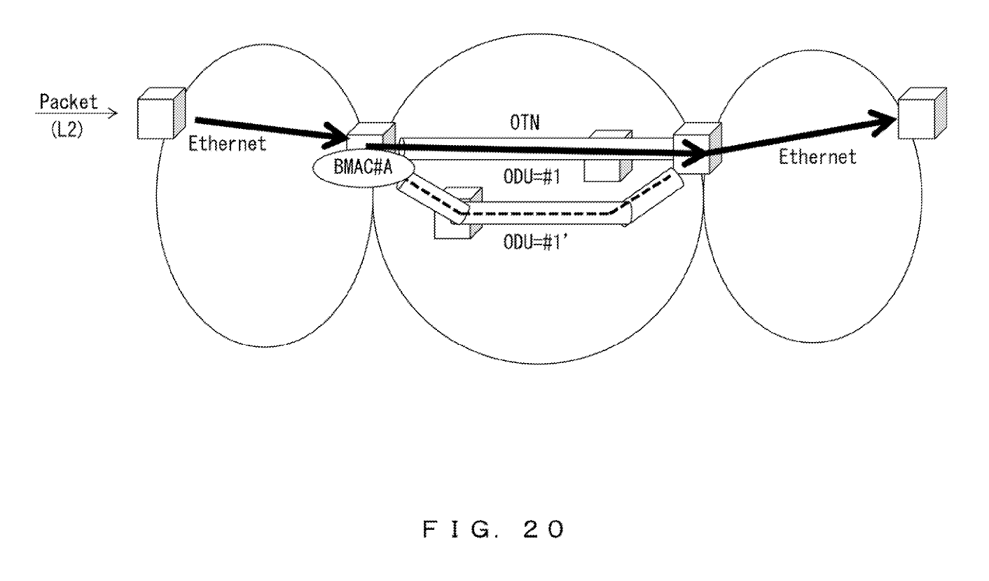

FIGS. 18 to 21 are explanatory views of a case where a redundant configuration is employed.

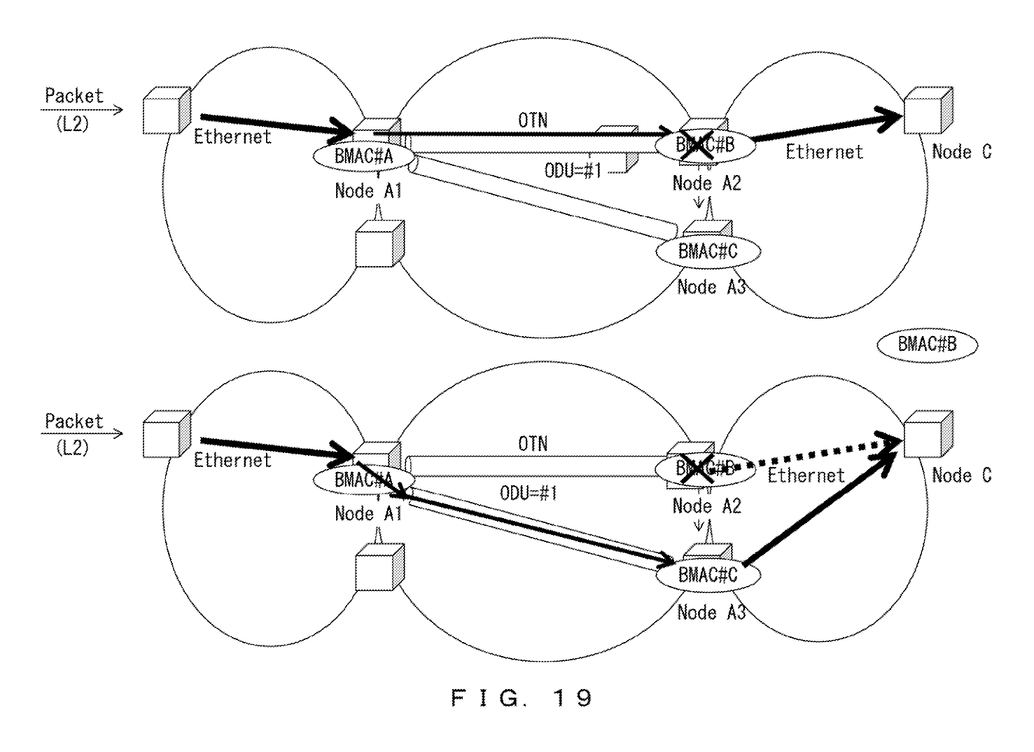

As illustrated in FIGS. 18 and 19, the edge apparatus can be also implemented as a redundant configuration.

In FIG. 18, if a fault occurs in Node A2, a neighboring ODU node (Node Z) and Node A3 detect the fault. Then, an ODU segment is set (for example, by Node Z) between the node that has detected the fault and the edge node (Node A3) that provides redundancy. This segment corresponds to ODU TCM (Tandem Connection Monitoring), and can be realized by forming TCM between Node Z-A2 and Node Z-A3. At the same time, a MAC management table possessed by Node A2 is imported to Node A3.

FIG. 19 illustrates a scheme of switching a frame not by Node Z but by Node A1, namely, an endpoint of a connection, when a fault of Node A2 is detected. An ODU segment is set between Node A1 and Node A3, and Node A3 performs operations as a replacement for Node A2. Similarly, the MAC management table possessed by Node A2 is imported to Node A3.

A redundancy for the connection can be realized by defining ODU protection stipulated by ITU-T G.873.1. Namely, ODU=#1 and ODU=#1′ are set for BMAC#A, and ODU=#1 is normally used. When a fault occurs in ODU#1, OUT=#1′ is used.

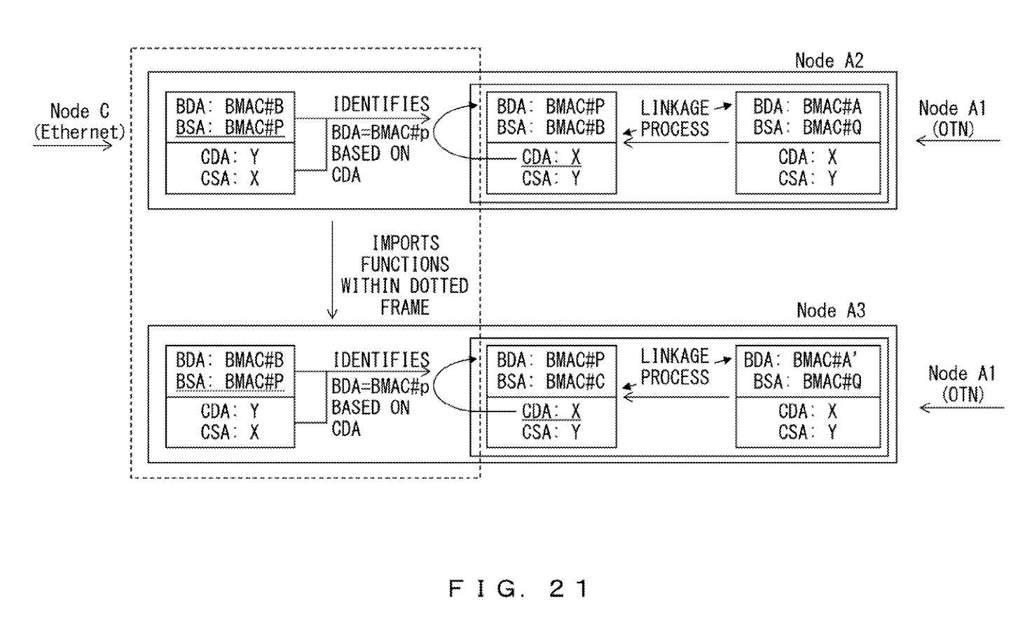

At the same time, the MAC management table possessed by Node A2 is imported to Node A3. Contents to be imported are those obtained by learning a MAC address of a frame transmitted from Node C of Ethernet in FIG. 19. As a result, a frame transmitted from Node A1 can be similarly transferred to Node C even after a fault occurs in Node A2. At this time, BMAC#A and BMAC#B are linked as MAC addresses that indicate an entry and an exit of the ODU path in Node A2. In Node A3, BMAC#A and BMAC#C are linked to each other. Accordingly, only B-SA is changed among addresses within a frame to be transmitted as illustrated in FIG. 21.

As described above, a MAC address is made to correspond to a connection such as an ODU endpoint or the like. An OTN edge apparatus does not forward a frame based on an address, namely, does not perform switching for selecting an ODU by analyzing an address. Therefore, in the edge apparatus, a seamless wide-area Ethernet via a core network such as an OTN or the like can be formed while reducing a circuit scale for analyzing an address. Moreover, since there is no need to attach an extra header for transferring a frame within a core network, a band of the network can be prevented from being overconsumed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relates to a showing of the superiority and inferiority of the invention. Although the embodiment of the present inventions has been described in detail, it should be understood that the various changes, substitutions, and alterations could be made hereto without departing from the spirit and scope of the invention.

1. A transmission apparatus that interconnects a first network for making a communication by forming a path and a second network for making a communication by adding an address to data and by executing a forwarding process, comprising:
a plurality of transmission units that are provided for each path and configured to transmit data to the path of the first network, to which the address of the second network is made to correspond; and
a transfer unit configured to receive the data of the second network, and to transfer the data to one of the plurality of transmission units, which corresponds to the address of the data.

2. The transmission apparatus according to claim 1, wherein
the address of the second network, which corresponds to the path, is made to correspond to each of a transmission end and a reception end of the path.

3. The transmission apparatus according to claim 1, wherein
the address of the second network, which corresponds to the path, is made to correspond to the path.

4. The transmission apparatus according to claim 1, wherein
the address is made to correspond to the path simultaneously with forming of the path of the first network.

5. The transmission apparatus according to claim 1, wherein
the second network is a PBB (Provider Backbone Bridge) network stipulated by IEEE 802.1ah, or a PB (Provider Bridge) network stipulated by IEEE 802.1ad.

6. The transmission apparatus according to claim 1, wherein
the first network is an OTN (Optical Transport Network).

7. The transmission apparatus according to claim 1, wherein
the first network is an MPLS (Multiprotocol Label Switching) network.

8. The transmission apparatus according to claim 1, wherein
a communication path to a transmission apparatus made redundant is provided when the first network and the second network are connected.

9. The transmission apparatus according to claim 8, performing path switching to the transmission apparatus made redundant, and executing an importing process of address management information, when a fault occurs.

10. The transmission apparatus according to claim 1, wherein
an address corresponding to the connection is made to correspond to a port of the transfer unit, which receives data from the second network.
